(19) United States
(12) Patent Application Publication
(10) Pub. No.: US 2026/0191359 A1
(43) Pub. Date: Jul. 9, 2026

(54) GRINDING CONTAINER THAT ALLOWS METICULOUS OPERATION

(71) Applicant: SAMHWA CO., LTD, Uiwang-si (KR)

(72) Inventors: Kyungchang LEE, Uiwang-si (KR); Kwan Ho LEE, Suwon-si (KR); Ga Yeon O, Ansan-si (KR)

(21) Appl. No.: 19/298,702

(22) Filed: Aug. 13, 2025

(30) Foreign Application Priority Data
Jan. 6, 2025 (KR) 10-2025-0001309

(51) Int. Cl. A47J 42/24; A47J 42/28; A47J 42/30

(52) U.S. Cl. CPC A47J 42/24; A47J 42/28; A47J 42/30

(57) ABSTRACT

A grinding container that allows meticulous operation in providing a solid product in a ground form is described. The grinding container includes a container body, a cutter plate, a piston, and a dial. The container body includes a main shell and a socket cylinder. A manipulation passageway is formed in the socket cylinder. The cutter plate covering the top of the mounting space formed by the main shell. A cutter blade configured to grind a solid content is provided on the cutter plate. The piston supporting the solid content is movable along the longitudinal direction. A guide slit is formed in the piston. The dial is rotatably coupled to the container body and includes a guide pillar that extends upward into the mounting space and is inserted through the manipulation passageway into the guide slit.

### CROSS-REFERENCE TO RELATED APPLICATIONS

This application claims the benefit of Korean Patent Application No. 10-2025-0001309, filed with the Korean Intellectual Property Office on January 6, 2025, the disclosure of which is incorporated herein by reference in its entirety.

### BACKGROUND

### Technical Field

The invention relates to a container for holding a solid product, more particularly to a grinding container that allows meticulous operation in providing a solid product in a ground form.

### Description of the Related Art

Certain functional compositions are manufactured and distributed in a solid form having a particular volume. While providing a composition in a solid form can provide the advantage that there is no risk of the content spilling or leaking as in the case of a liquid product, a solid product can be more difficult to apply onto a required area than a liquid product. A recent development that allows easier use of a solid product is the grinding container, in which a cutter blade is provided on the container itself to grind the solid product before dispensing the ground powder.

In a grinding container, some components remain stationary and some components are rotated, so that the components are frequently moved in relation to one another. Also, some components must push the solid product upward according to the manipulation made by the user. While such a structure requires that all of the components maintain a completely aligned state in order for the product to be used properly, too much rigidity in the parts supporting the moving components can lead to stresses being concentrated at certain parts and can thus create a risk of wear and damage in said parts, whereas too much flexibility in the parts supporting the moving components can result in the content failing to maintain an aligned state, so that the grinding operation may not be properly achieved.

Also, when a user rotates a manipulation part to manipulate the grinding container, the user must exert force to grind the solid content, and it can be difficult for the user to guess how much the manipulation part should be rotated. As a result, the user may dispense the content in excess of the desired amount, thus incurring unnecessary waste. Also, when manipulating the grinding container, the user must rotate the manipulation part in a designated direction, but from the perspective of the user, it may be unclear which part is to be rotated in which direction. In particular, if the user rotates the manipulation part several times in the wrong direction, the content may be moved away from the cutter part. In this case, the content would not be provided regardless of which direction the user turns the manipulation part, exacerbating the user’s confusion.

### SUMMARYOF THE INVENTION

An aspect of the invention, which was conceived to resolve the problem described above, is to provide a grinding container that allows the parts for supporting the moving components to have a suitable degree of flexibility while keeping the content aligned in a stable manner.

Another aspect of the invention is to provide a grinding container that can be used conveniently.

Other objectives of the invention will be more clearly understood from the embodiments set forth below.

One aspect of the invention provides a grinding container that includes a container body, a cutter plate, a piston, and a dial. The container body may include a main shell and a socket cylinder, where a mounting space that is open at the top may be formed on the inner side of the main shell, and where the socket cylinder may be located at a lower portion on the inner side of the main shell and may extend a particular length along a longitudinal direction. A manipulation passageway may be formed on the inner side of the socket cylinder, such that the mounting space may be in communication with the exterior. The cutter plate may be secured in relation to the container body at a position covering the top of the mounting space. A cutter blade configured to grind a solid content may be provided on a bottom surface of the cutter plate, and a discharge hole penetrating the cutter plate along the longitudinal direction may be formed in the cutter plate to discharge the ground solid content. At least a portion of the piston may be arranged within the mounting space to support the solid content, and the piston may be configured to be movable along the longitudinal direction in relation to the container body. A guide slit may be formed in an upper surface of the piston, where the guide slit may penetrate the upper surface of the piston along the longitudinal direction. The dial may be rotatably coupled to a lower portion of the container body and may include a guide pillar that extends upward into the mounting space and is inserted through the manipulation passageway into the guide slit, such that an upper end of the guide pillar is located within the mounting space. Here, the piston may include a stem that extends downward such that at least a portion of the stem is located within the manipulation passageway. A thread may be provided on one of an inner perimeter of the socket cylinder and an outer perimeter of the stem, and a mating protrusion configured to engage the thread may be provided on the other of the inner perimeter of the socket cylinder and the outer perimeter of the stem.

A grinding container according to an embodiment of the invention can include one or more of the following features. For example, one of the container body and the dial can include a stationary sawtooth part and the other of the container body and the dial can include a movable sawtooth part. The stationary sawtooth part can include at least one stationary sawtooth that protrudes along the longitudinal direction or the radial direction, and the movable sawtooth part can include at least one movable sawtooth. The movable sawtooth can include a cantilever portion, of which one end is secured, and a sawtooth portion, which protrudes in an opposite direction of the protruding direction of the stationary sawtooth.

The stationary sawtooth part can include a multiple number of stationary sawteeth that are formed continuously along an annular path, or the movable sawtooth part can include a multiple number of movable sawteeth that are formed continuously along an annular path.

The stationary sawtooth can include a first sloped surface formed on one side and a first stopper surface formed on the other side with respect to a circumferential direction, and the movable sawtooth can include a second sloped surface formed on the other side and a second stopper surface formed on the one side with respect to the circumferential direction, such that rotating the dial in a first direction can cause the first sloped surface to contact the second sloped surface and rotating the dial in a second direction that is opposite the first direction can cause the first stopper surface to contact the second stopper surface.

The container body can include a floor part that has a flat shape and is provided at a lower portion of the main shell, and the stationary sawtooth part or the movable sawtooth part can be formed on the floor part.

A groove extending along the longitudinal direction can be formed in an inner perimeter of the stem, and an outer side of the guide pillar can be inserted in the groove.

The dial can include an insertion coupling part that extends upward. One of the insertion coupling part and the stem can form an insertion space on the inner side, and the other of the insertion coupling part and the stem can include a support pillar that is inserted into the insertion space. The cross section of the insertion space and the cross section of the support pillar can be formed in non-circular shapes so as to prevent the piston from rotating in relation to the dial while allowing the piston to move along the longitudinal direction in relation to the dial.

An embodiment of the invention having the features above can provide various advantageous effects including the following. However, an embodiment of the invention may not necessarily exhibit all of the effects below.

An embodiment of the invention can provide a convenient grinding container that allows the user to grind a solid content with a simple action of rotating a dial.

A grinding container according to an embodiment of the invention allows the user to perceive the degree to which the dial is rotated, so that the user may manipulate the grinding container meticulously and grind the content in a suitable, desired amount every time. Also, a grinding container according to an embodiment of the invention can prevent the dial from rotating in the opposite direction, thereby saving the user from unnecessary confusion.

A grinding container according to an embodiment of the invention is structured such that the moving parts and the supporting parts are flexible to a suitable extent but are nevertheless able to support the content in a stable manner and keep the content in an aligned state.

### BRIEF DESCRIPTION OF THE DRAWINGS

FIG. 1 is a perspective view of a grinding container according to a first disclosed embodiment of the invention.

FIG. 2 is an exploded perspective view of the grinding container shown in FIG. 1.

FIG. 3 is a cross-sectional view of the grinding container shown in FIG. 1.

FIG. 4 is a perspective view of the dial in the grinding container shown in FIG. 1, as seen from above.

FIG. 5 is a perspective view of the dial in the grinding container shown in FIG. 1, as seen from below.

FIG. 6 is a perspective view of the container body in the grinding container shown in FIG. 1, as seen from above.

FIG. 7 is a perspective view of the container body in the grinding container shown in FIG. 1, as seen from below.

FIG. 8 is a perspective view of the piston in the grinding container shown in FIG. 1, as seen from above.

FIG. 9 is a perspective view of the piston in the grinding container shown in FIG. 1, as seen from below.

FIG. 10 is a perspective view of the cutter plate in the grinding container shown in FIG. 1, as seen from above.

FIG. 11 is a perspective view of the cutter plate in the grinding container shown in FIG. 1, as seen from below.

FIG. 12 is a perspective view of a grinding container according to a second disclosed embodiment of the invention.

FIG. 13 is an exploded perspective view of the grinding container shown in FIG. 12.

FIG. 14 is a cross-sectional view of the grinding container shown in FIG. 12.

FIG. 15 is a perspective view of the dial in the grinding container shown in FIG. 12, as seen from above.

FIG. 16 is a perspective view of the dial in the grinding container shown in FIG. 12, as seen from below.

FIG. 17 is a perspective view of the container body in the grinding container shown in FIG. 12, as seen from above.

FIG. 18 is a perspective view of the container body in the grinding container shown in FIG. 12, as seen from below.

FIG. 19 is a perspective view of the piston in the grinding container shown in FIG. 12, as seen from above.

FIG. 20 is a perspective view of the piston in the grinding container shown in FIG. 12, as seen from below.

FIG. 21 is a perspective view of the cutter plate in the grinding container shown in FIG. 12, as seen from above.

FIG. 22 is a perspective view of the cutter plate in the grinding container shown in FIG. 12, as seen from below.

### DETAILED DESCRIPTION OF THE INVENTION

As the invention allows for various changes and numerous embodiments, particular embodiments will be illustrated in the drawings and described in detail in the written description. However, this is not intended to limit the invention to particular modes of practice, and it is to be appreciated that all changes, equivalents, and substitutes that do not depart from the spirit and technical scope of the invention are encompassed by the invention. In the description of the invention, certain detailed explanations of the related art are omitted if it is deemed that they may unnecessarily obscure the essence of the invention.

The terms used in the present specification are merely used to describe particular embodiments and are not intended to limit the invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

While such terms as “first” and “second,” etc., can be used to describe various components, such components are not to be limited by the above terms. The above terms are used only to distinguish one component from another.

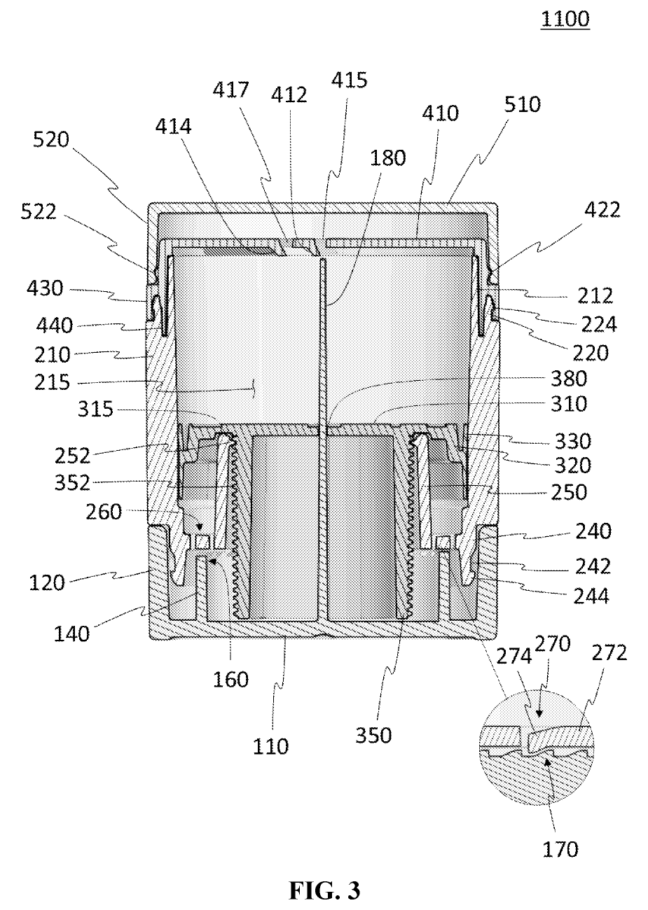

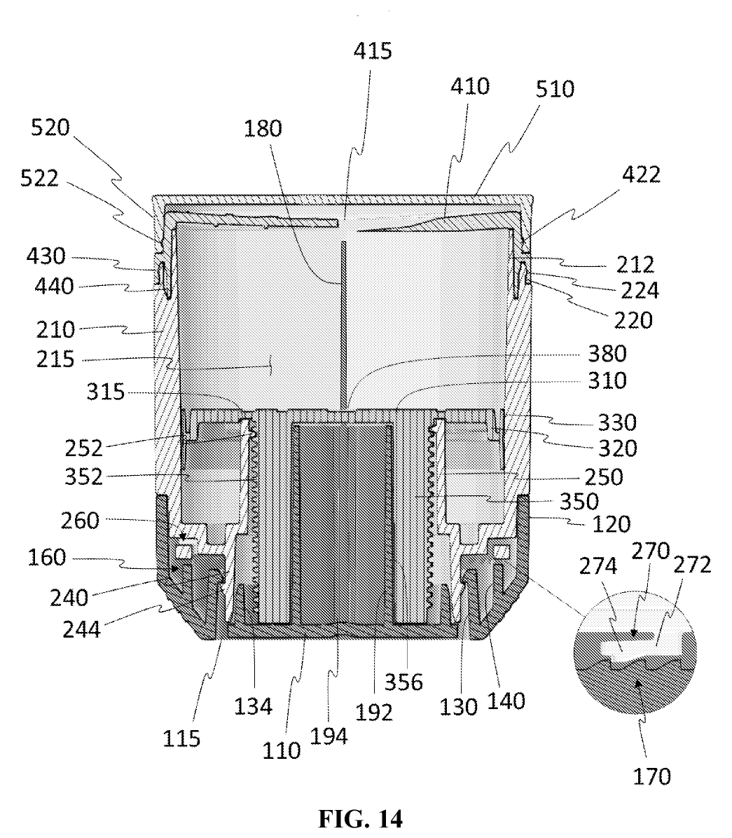

For convenience, the specification uses terms such as “inner”, “outer”, “upper”, and “lower”. In the descriptions below, an “inner” side refers to a side closer to the interior of the grinding container 1100, 1200, whereas an “outer” side refers to a side further away from the interior of the grinding container 1100, 1200. The terms “upper” and “lower” are used to describe the grinding container 1100, 1200 when it is oriented as in FIG. 3 and FIG. 14, while the term “longitudinal direction” is used to describe a direction running along the upward and downward directions. Of course, when a grinding container 1100, 1200 according to an embodiment of the invention is actually in use, the directions mentioned in the specification may not coincide with the actual directions of the parts described.

Certain embodiments of the invention will be described below in more detail with reference to the accompanying drawings. Those components that are the same or are in correspondence are rendered the same reference numeral, and redundant descriptions are omitted.

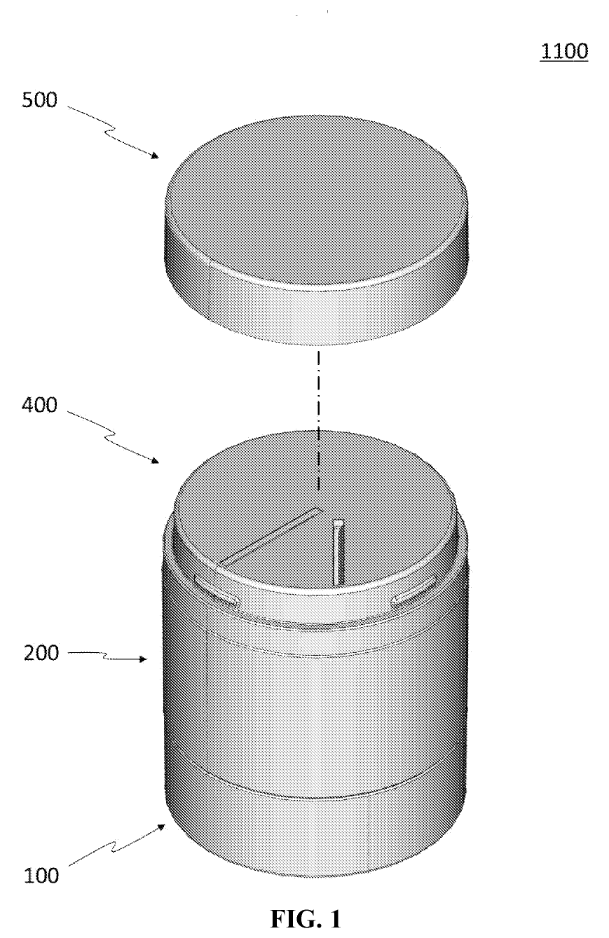

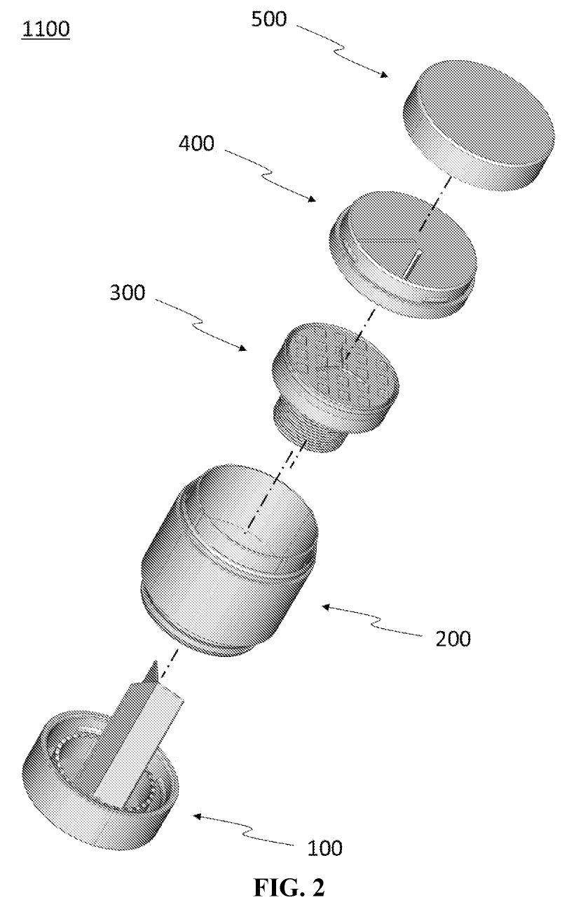

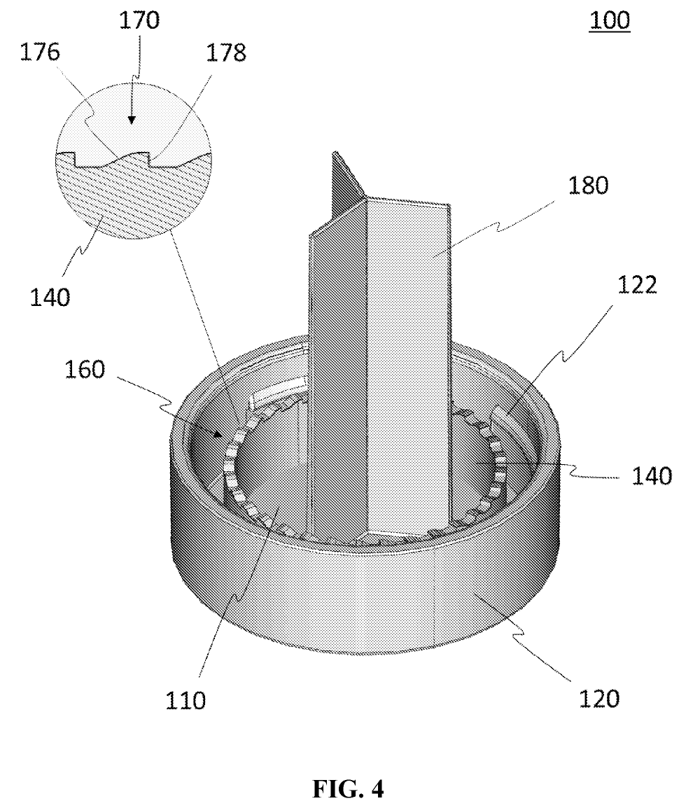

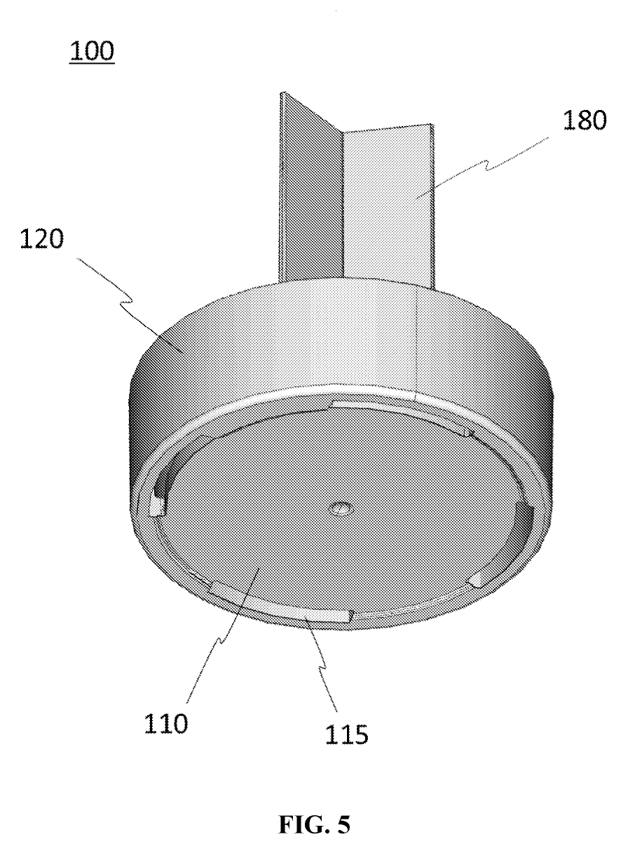

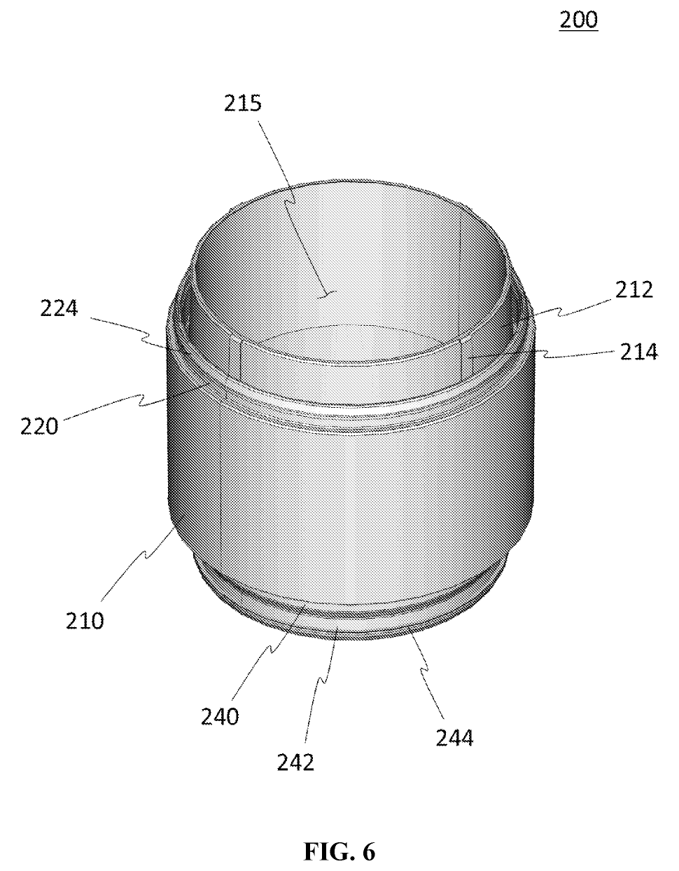

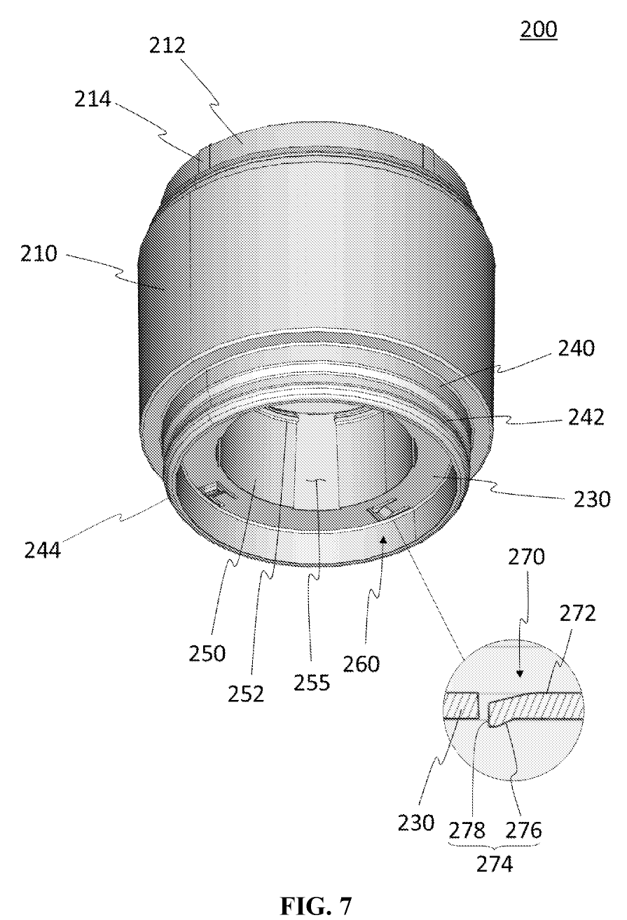

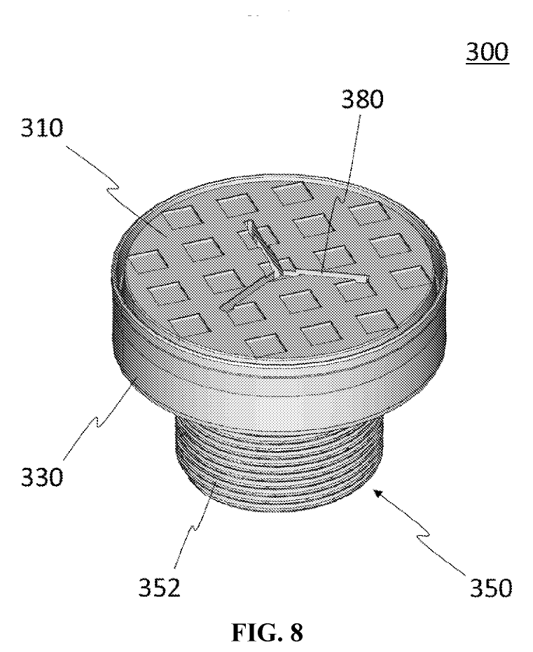

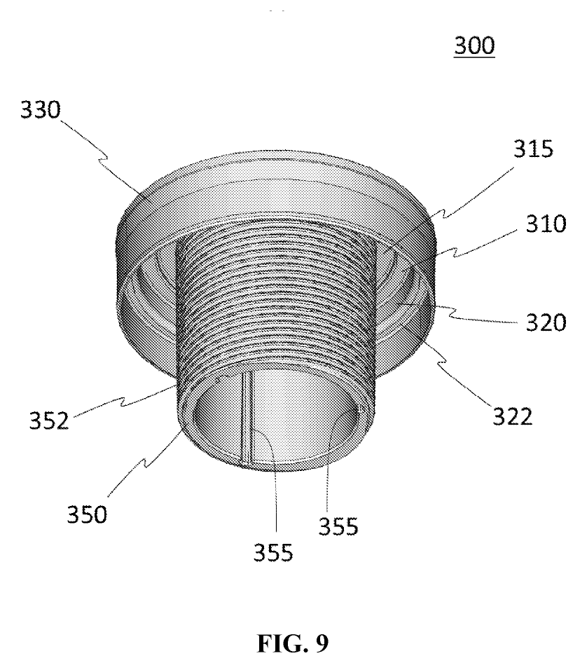

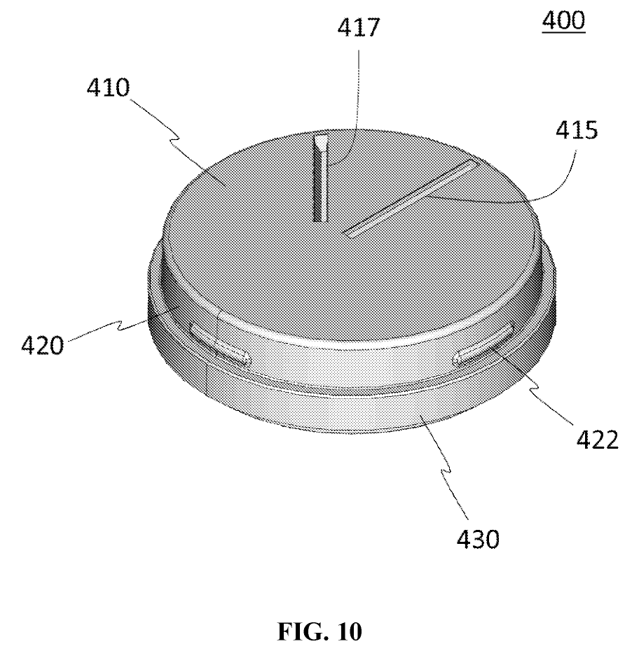

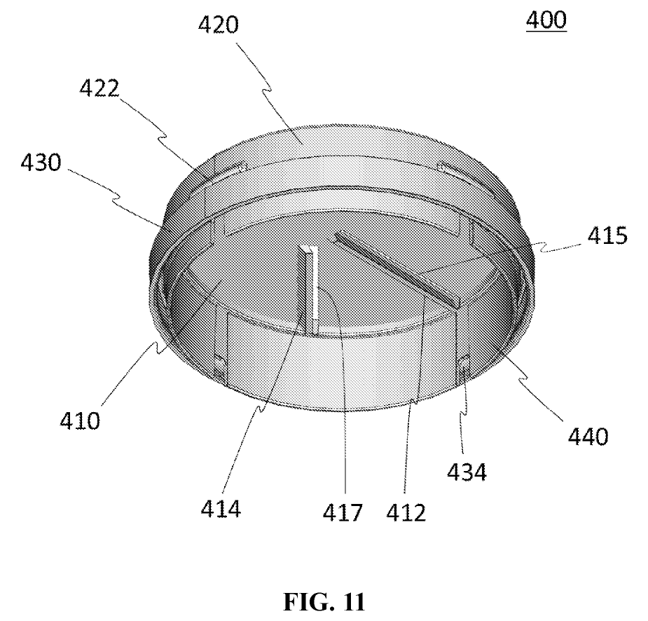

FIG. 1 through FIG. 3 illustrate a grinding container 1100 according to a first disclosed embodiment of the invention. As shown in the drawings, a grinding container 1100 according to an embodiment of the invention can include a dial 100, a container body 200, a piston 300, a cutter plate 400, and an overcap 500. FIG. 4 and FIG. 5 illustrate the dial 100 in greater detail, while FIG. 6 and FIG. 7 illustrate the container body 200 in greater detail. FIG. 8 and FIG. 9 illustrate the piston 300 in greater detail, while FIG. 10 and FIG. 11 illustrate the cutter plate 400 in greater detail.

The dial 100 corresponds to the part that is held and manipulated by a user using the grinding container 1100 and, for this purpose, may be rotatably coupled to a lower portion of the container body 200. Referring to FIGS. 1 to 5, the dial 100 can include a circular plate 110, a side wall 120, a protruding inner wall 140, a stationary sawtooth part 160, and a guide pillar 180.

The circular plate 110 can form a lower surface of the dial 100 and serve as a base for other components of the dial 100. In a preferred embodiment, the circular plate 110 can be formed in a size and shape that can cover the bottom of the socket cylinder 250 of the container body 200. Although the drawings depict the circular plate 110 of the dial 100 as having a circular shape, and although the dial 100 is a part that is rotated by the user, it is not absolutely necessary that the circular plate 110 have a circular shape.

A multiple number of allowance slits 115 can be formed in the circular plate 110. Each of the allowance slits 115 can at least partially be formed in the shape of an arc and can be formed under the coupling protrusions 122 formed on the side wall 120. The allowance slits 115 make it possible to mold the dial 100 by way of an upper and a lower cast even when the side wall 120 of the dial 100 includes coupling protrusions 122 that protrude inward.

The side wall 120 can extend up from the edge of the circular plate 110. The length by which the side wall 120 extends upward can be determined such that, when the dial 100 is coupled to the container body 200, the upper end of the side wall 120 is in contact with or adjacent to the main shell 210 of the container body 200. Also, the position and size of the side wall 120 can be determined such that the outer surface of the side wall 120 is flush with the outer surface of the main shell 210. The side wall 120 can be formed along the entire edge of the circular plate 110 so as to hide its inner side.

One or more coupling indentations and coupling protrusions can be formed on the dial 100 and container body 200 for coupling with each other, and these can be formed as part of a structure that allows the dial 100 to be rotatable in relation to the container body 200. In the example illustrated in FIGS. 1 to 3, coupling protrusions 122 protruding inward are formed on the inner perimeter of the side wall 120, and these can be inserted into a coupling groove 242 formed in the lower coupling rim 240 of the container body 200.

The protruding inner wall 140 can extend upward at an inner side of the side wall 120 and can provide a location for the stationary sawtooth part or the movable sawtooth part. The protruding inner wall 140 can structurally support the stationary sawtooth part or the movable sawtooth part and can position the stationary sawtooth part or movable sawtooth part at the required height.

In the example shown in FIGS. 1 to 3, the dial 100 includes the stationary sawtooth part 160, while the container body 200 includes the movable sawtooth part 260.

The stationary sawtooth part 160 can interact with the movable sawtooth part 260 to allow the user to perceive the degree to which the dial 100 has been rotated when the user rotates the dial 100. In certain embodiments, the stationary sawtooth part 160 and the movable sawtooth part 260 can be configured to allow the dial 100 to rotate only in a particular direction and prevent the dial 100 from rotating in the opposite direction.

The stationary sawtooth part 160 can include at least one stationary sawtooth 170. In the present specification, a stationary sawtooth 170 refers to an individual sawtooth, while the stationary sawtooth part 160 refers collectively to the part that includes one or multiple stationary sawteeth 170. Similarly, the movable sawtooth part 260 can include at least one movable sawtooth 270, where a movable sawtooth 270 refers to an individual sawtooth, while the movable sawtooth part 260 refers collectively to the part that includes one or multiple movable sawteeth 270.

In the example shown in FIGS. 1 to 3, the dial 100 includes the stationary sawtooth part 160, and the container body 200 includes the movable sawtooth part 260. However, in certain other embodiments of the invention, it is possible to have the dial 100 include the movable sawtooth part and the container body 200 include the stationary sawtooth part.

In the example shown in FIGS. 1 to 3, the stationary sawtooth part 160 includes a multiple number of stationary sawteeth 170 that are formed continuously along an annular path. The stationary sawteeth 170 can all protrude in the direction of the movable sawtooth part 260. Although the drawings present an example in which the stationary sawteeth 170 protrude upward towards the movable sawtooth 270 from the upper end of the protruding inner wall 140, it is possible, for example in a structure where the stationary sawteeth 170 are formed on the container body 200 or in some other structure, to have the stationary sawteeth 170 protrude downward towards the movable sawteeth 270. That is, the stationary sawteeth 170 can protrude along a longitudinal direction. Also, in certain embodiments not shown in the drawings, the stationary sawteeth 170 can, for example, protrude inward or outward from the outer perimeter or inner perimeter of the protruding inner wall 140. That is, the stationary sawteeth 170 can protrude along a radial direction.

Also, although the example shown in FIGS. 1 to 3 depict the stationary sawteeth 170 of the stationary sawtooth part 160 as being formed continuously and the movable sawteeth 270 of the movable sawtooth part 260 as being formed only at a few designated positions, certain other embodiments of the invention not shown in the drawings can have a multiple number of movable sawteeth 270 formed continuously and a fewer number of stationary sawteeth 170 formed only at a few designated positions.

The upper left part of FIG. 4 depicts a stationary sawtooth 170. Referring to FIG. 4, each stationary sawtooth 170 can protrude towards the movable sawtooth 270 (in an upward direction in the upper left drawing of FIG. 4), where a first sloped surface 176 may be formed on one side (on the left side in the upper left drawing of FIG. 4) with respect to the circumferential direction, and a first stopper surface 178 may be formed on the other side (on the right side in the upper left drawing of FIG. 4). A flat portion of a particular length can be formed between the first sloped surface 176 and the first stopper surface 178, and a flat portion of a particular length can also be formed between adjacent stationary sawteeth 170.

Incidentally, the lower right part of FIG. 7 depicts a movable sawtooth 270. Referring to FIG. 7, each movable sawtooth 270 can include a cantilever portion 272 and a sawtooth portion 274. The cantilever portion 272 can be implemented with one end in a secured state, and the sawtooth portion 274 can be formed on the other end of the cantilever portion 272. On each movable sawtooth 270, the sawtooth portion 274 can protrude towards the corresponding stationary sawteeth 170 (in a downward direction in the lower right drawing of FIG. 7), where a second stopper surface 278 can be formed on one side (on the right side in the lower right drawing of FIG. 7) with respect to the circumferential direction, and a second sloped surface 276 can be formed on the other side (on the left side in the lower right drawing of FIG. 7). The cantilever portion 272 of the movable sawtooth 270 can be elastically deformed to allow a movement of the sawtooth portion 274, so that the sawtooth portion 274 may retract away from the stationary sawtooth 170.

The guide pillar 180 can extend up from an upper surface of the circular plate 110. In a preferred embodiment of the invention, the dial 100 can include a multiple number of guide pillars 180, where the side surfaces of each guide pillar 180 can be flat in shape. In the example shown in FIG. 4 and FIG. 5, a multiple number of guide pillars 180 are connected to one another at the middle.

According to an embodiment of the invention, each guide pillar 180 can have a cross section that extends along an imaginary line which passes through the center of the circular plate 110. That is, each guide pillar 180 can be arranged such that the inward side of the guide pillar 180 faces the center of rotation of the dial 100, whereby the relatively broader side surface of the guide pillar 180 may face a direction that resists rotation. Such shape of the guide pillar 180 can aid in preventing any relative rotation of the piston 300 with respect to the dial 100.

Referring to FIG. 3, the guide pillars 180 can pass through guide slits 380 formed in the holder plate 310 of the piston 300. Since a solid content (not shown) is arranged on the holder plate 310 of the piston 300, and since the guide pillars 180 extend through the holder plate 310, there can also be guide slits formed in the solid content (not shown) arranged on the holder plate 310, in the same size and shape as those of the guide slits 380.

The container body 200, which corresponds to the main part of the grinding container 1100, can form the body onto which other components may be coupled and can also house the content (not shown) within. Referring to FIG. 6 and FIG. 7, the container body 200 can include a main shell 210, an inner coupling rim 212, an outer coupling rim 220, a floor part 230, a lower coupling part 240, and a socket cylinder 250.

The main shell 210 can form the main part of the container body 200 and can have a generally cylindrical shape. The main shell 210 can form a mounting space 215 on its inner side, where the piston 300 and the solid content (not shown) placed on the piston 300 can be housed in the mounting space 215. As in the example shown in the drawings, the main shell 210 can form a part of the exterior of the grinding container 1100.

The inner coupling rim 212 corresponds to an upper portion of the main shell 210 and can also be used for coupling with the cutter plate 400. In the example shown in FIG. 3 and FIG. 6, the inner coupling rim 212 has a smaller thickness compared to the remaining part of the main shell 210, but the inner perimeter of the inner coupling rim 212 is continuous with the inner perimeter of the remaining part of the main shell 210, so that the mounting space 215 can maintain a unified shape even at the portion of the inner coupling rim 212. Of course, in certain embodiments, the inner coupling rim 212 can be formed with a shape and position that are independent of the remaining part of the main shell 210.

The outer coupling rim 220 can extend upward from an upper portion of the main part of the main shell 210 and can have a larger diameter than that of the inner coupling rim 212 such that a gap is formed between the outer coupling rim 220 and the inner coupling rim 212. The inner coupling rim 212 and the outer coupling rim 220 can be used for coupling the cutter plate 400 onto the container body 200 as well as for supporting the cutter plate 400 in a stable manner. For example, inner coupling rims 440 of the cutter plate 400 can be inserted into the gap between the inner coupling rim 212 and the outer coupling rim 220.

One or more coupling indentations, coupling protrusions, securing indentations and/or securing protrusions can be formed in at least one of the inner coupling rim 212 and outer coupling rim 220. For example, in the example shown in FIG. 6, securing protrusions 214 are formed on the outer perimeter of the inner coupling rim 212. The securing protrusions 214 can protrude outward from one or more designated positions on the outer perimeter of the inner coupling rim 212. When the cutter plate 400 is coupled to the container body 200, the securing protrusions 214 can be inserted into securing grooves 434 formed in-between the inner coupling rims 440 of the cutter plate 400, whereby the cutter plate 400 can be prevented from rotating relative to the container body 200.

In the example shown in the drawings, a coupling protrusion 224 is also formed on the outer perimeter of the outer coupling rim 220. The coupling protrusion 224 can extend along most of the outer perimeter of the outer coupling rim 220 to form a generally annular shape. When the cutter plate 400 is coupled to the container body 200, the coupling protrusion 224 can be inserted into a coupling groove formed in the outer coupling rim 430 of the cutter plate 400, so that the cutter plate 400 may be prevented from becoming separated from the container body 200 along the longitudinal direction.

The floor part 230 can be formed at a lower portion of the main shell 210, can define the bottom of the mounting space 215, and can connect the main shell 210 with the socket cylinder 250. The floor part 230 can include a portion having a flat shape, and in the example shown in the drawings, the movable sawtooth part 260 is formed on the floor part 230. As already described above, the positions of the stationary sawtooth part 160 and the movable sawtooth part 260 on the dial 100 and the container body 200 can be interchanged, as long as they are in corresponding positions. That is, in certain embodiments, it is possible to have the stationary sawtooth part to be provided on the floor part 230 or on another position of the container body 200.

The lower coupling part 240 can be formed at a lower portion of the main shell 210 and can be used for coupling the dial 100 to the container body 200 such that the dial is rotatable in relation to the container body 200. In an embodiment of the invention, the lower coupling part 240 can have a reduced outer diameter compared to the main shell 210, and when the dial 100 is coupled to the container body 200, the lower coupling part 240 can be positioned on the inner side of the side wall 120 of the dial 100 and thus be hidden.

As described above, coupling indentations and coupling protrusions can be formed on the dial 100 and the container body 200 for the coupling with each other, where these can be formed as part of a structure that allows the dial 100 to be rotatable in relation to the container body 200. In the example shown in the drawings, a coupling groove 242 and a coupling protrusion 244 having annular shapes are formed on the outer perimeter of the lower coupling part 240. When the dial 100 is coupled to the container body 200, the coupling protrusions 122 formed on the inner perimeter of the side wall 120 can be inserted into the coupling groove 242 of the lower coupling rim 240, and the lower portions of the coupling protrusions 122 can be caught on the coupling protrusion 244. To allow an easier coupling of the dial 100, the upper portions of the coupling protrusions 122 formed on the dial 100 and the lower portion of the coupling protrusion 244 formed on the lower coupling rim 240 can be formed to have sloped surfaces.

The socket cylinder 250 can be formed at a designated position at a lower portion on the inner side of the main shell 210 and can be connected to the main shell 210 by the floor part 230. The socket cylinder 250 can extend a particular length along the longitudinal direction and can form a manipulation passageway 255 on its inner side. The socket cylinder 250 can be shaped as a cylinder having an open top and bottom, so that the manipulation passageway 255 may connect to the mounting space 215 at the top and connect to the exterior at the bottom. That is, the socket cylinder 250 can connect the mounting space 215 with the exterior through the manipulation passageway 255.

The manipulation passageway 255 of the socket cylinder 250 may provide a passageway through which the dial 100, which is arranged on the outer side of the container body 200, and the piston 300, which is arranged on the inner side of the container body 200, may interact with each other. In an embodiment of the invention, the socket cylinder 250 itself can participate in the operation of the dial 100 and the piston 300. For example, a thread can be provided on one of the inner perimeter of the socket cylinder 250 and the outer perimeter of the stem 350 of the piston 300, while a mating protrusion configured to engage the thread can be provided on the other. In a preferred embodiment, the diameter of the socket cylinder 250 can be designed to be greater than or equal to a half of the diameter of the holder plate 310 of the piston 300.

In the example shown in FIG. 3 and FIG. 7, the mating protrusion 252 is formed on the inner perimeter of the socket cylinder 250. The mating protrusion 252 can be formed at a position close to the upper end of the socket cylinder 250 and can have a shape corresponding to a screw so as to engage the thread 352 formed on the stem 350 of the piston 300. Of course, the mating protrusion 252 itself can also be implemented in the form of a thread. That is, in an embodiment of the invention, the mating protrusion 252 can be implemented in the form of a thread (i.e., a female thread) formed over the entire inner perimeter of the socket cylinder 250.

The piston 300 is the part that supports the content (not shown) and is moved along the longitudinal direction as a result of a manipulation made by the user. Referring to FIG. 8 and FIG. 9, the piston 300 can include a holder plate 310, a connecting part 320, a contact part 330, and a stem 350.

The holder plate 310 is the part that supports the solid content (not shown) on its upper surface and can generally be shaped as a flat circular plate. The content (not shown) can include a composition for a product such as a cleansing balm, deodorant, etc., and can be supplied in a solid form on the holder plate 310. In order that the content (not shown) may not be easily separated, a downwardly recessed portion and/or an upwardly protruding portion can be formed on the holder plate 310.

Guide slits 380 can be formed in the holder plate 310, and similar guide slits can also be formed in the content (not shown) provided on the holder plate 310. The guide pillars 180 of the dial 100 can extend up through the guide slits 380 and can also pass through a portion of the content (not shown) arranged on the holder plate 310.

As illustrated in FIG. 9, an alignment groove 315 can be formed in the bottom surface of the holder plate 310 around the stem 350. The alignment groove 315 can be formed in a position corresponding to the upper end of the socket cylinder 250 of the container body 200. When the piston 300 is at its lowest position within the mounting space 215, as illustrated in FIG. 3, the upper end of the socket cylinder 250 can be inserted in the alignment groove 315.

The connecting part 320 can extend down from the edge of the holder plate 310. The connecting part 320, which is a part that connects the contact part 330 to the holder plate 310, can support the contact part 330 at a middle height of the contact part 330 with respect to the longitudinal direction such that the upper end of the contact part 330 is at a position close to the upper surface of the holder plate 310.

The contact part 330 can be positioned at the edge of the piston 300 and can be connected by a connecting flange 322 to a lower portion of the connecting part 320. The contact part 330 can extend up and down and can be formed in a thickness that allows a slight degree of flexibility. Using the middle height of the contact part 330 as a reference point, the outer diameter can increase towards the top at the upper portion of the contact part 330, while the outer diameter can decrease towards the bottom at the lower portion of the contact part 330. This allows the contact part 330 to tightly contact the inner perimeter of the main shell 210 in a relatively watertight manner, so as to minimize any leaking of the content (not shown) below the piston 300.

The stem 350 can extend downward from a bottom surface of the holder plate 310. In an embodiment of the invention, the diameter of the stem 350 can be designed to be greater than or equal to a half of the diameter of the holder plate 310. As described above, in an embodiment of the invention, a thread can be provided on one and a mating protrusion engaging the thread can be provided on the other of the inner perimeter of the socket cylinder 250 and the outer perimeter of the stem 350. In the example shown in the drawings, a thread 352 is formed on the outer perimeter of the stem 350 of the piston 300. While the piston 300 is in a coupled state with the container body 200, the mating protrusion 252 of the socket cylinder 250 can mate with the thread 352 of the stem 350. In certain embodiments of the invention, it is possible to have the mating protrusion formed on the stem 350 and the thread formed on the socket cylinder 250.

The drawings illustrate an example in which the stem 350 of the piston 300 is inserted to the inner side of the socket cylinder 250, so that the thread 352 is formed on the outer perimeter of the stem 350 and the mating protrusion 252 is formed on the inner perimeter of the socket cylinder 250. However, in certain embodiments of the invention, it is possible to have the socket cylinder 250 inserted to the inner side of the stem 350, in which case the thread and the mating protrusion can be formed on the outer perimeter of the socket cylinder 250 and the inner perimeter of the stem 350. Of course, in such cases, the length by which the stem 350 extends downwards can be limited by the position of the floor part 230.

Referring to FIG. 9, one or more grooves 355 can be formed in the inner perimeter of the stem 350. The groove 355 may be an indentation extending along the longitudinal direction. When the piston 300 is arranged within the mounting space 215 and the dial 100 is coupled, the outer portions of the guide pillars 180 of the dial 100 can be inserted in the grooves 355. This structure allows the piston 300 to rotate together with the dial 100, i.e., prevents the piston 300 from rotating relative to the dial 100, while allowing the piston 300 to move along the longitudinal direction.

The cutter plate 400 can be positioned at an upper portion of the container body 200 to cover the mounting space 215 in which the content (not shown) is housed and can serve to grind the content (not shown) using cutter blades 412, 414 before providing the ground content to the user. Referring to FIG. 10 and FIG. 11, the cutter plate 400 can include a cover plate 410, a side wall 420, an outer coupling rim 430, and an inner coupling rim 440.

The cover plate 410 corresponds to the main part of the cutter plate 400 and can cover the open top of the mounting space 215. On the bottom surface of the cover plate 410, cutter blades 412, 414 may be provided, which are configured to grind the solid content (not shown). In the cover plate 410 itself, discharge holes 415, 417 may be formed, which penetrate the cover plate 410 along the longitudinal direction so as to discharge the ground solid content (not shown). Although the drawings depict the cover plate 410 as having a circular shape, and although the cutter plate 400 is a part that is rotated relative to the dial 100, it is not absolutely necessary that the cover plate 410 have a circular shape.

According to an embodiment of the invention, each of the cutter blades 412, 414 can be provided at a position adjacent to a corresponding discharge hole 415, 417. Therefore, when the cutter blades 412, 414 grind a portion of the solid content (not shown), the ground content can immediately pass through the adjacent discharge holes 415, 417 and be provided to the upper surface of the cover plate 410.

In the example shown in the drawings, the cover plate 410 includes a main cutter blade 412 and an auxiliary cutter blade 414. The main cutter blade 412 and its adjacent discharge hole 415 may extend inward from the edge of the cover plate 410 along a first direction, extending to a point corresponding to the center of the cover plate 410 or a point beyond the center of the cover plate 410 with respect to the first direction. Here, the center of the cover plate 410 can be regarded as being substantially the same as the center of the cutter plate 400 and may correspond to the center of rotation for the rotation relative to the piston 300 and content (not shown). If the cutter blade 412 were to extend only up to a point that does not reach the center of the cover plate 410, the content (not shown) would not be ground at the portion under the center of the cover plate 410, so that the upper surface of the solid content (not shown) may not maintain a uniform height. This can lead to various problems, such as an inability to grind and provide the content, even when the dial 100 is rotated, and excessive pressure being applied on the cover plate 410 by the unground portion of the content.

The auxiliary cutter blade 414 and its adjacent discharge hole 417 may extend inward from the edge of the cover plate 410 along a second direction, but it is acceptable for these to extend only up to a point that does not pass beyond the center of the cover plate 410 with respect to the second direction. The auxiliary cutter blade 414 can grind the content at a rear position of the main cutter blade 412.

In the example shown in the drawings, each of the cutter blades 412, 414 extend along imaginary straight lines. Of course, the cutter blades 412, 414 do not necessarily have be formed along straight lines and can just as well be formed along curved lines. In cases where the cutter blades 412, 414 extend along imaginary lines, the lines can be arranged so as not to pass the center of the cover plate 410. Such an arrangement makes it possible for multiple cutter blades 412, 414 to extend up to positions that pass beyond the center of the cover plate 410.

The side wall 420 can extend along the longitudinal direction from the edge of the cover plate 410. Although the drawings depict an example in which the side wall 420 extends downward only, it is possible in certain other embodiments for the side wall 420 to extend above the cover plate 410. Since the cover plate 410 is provided with cutter blades 412, 414, having the side wall 420 protrude upward can protect surrounding objects from contacting the cutter blades 412, 414 too easily. The side wall 420 can also be used for coupling the overcap 500 to the cutter plate 400, and for this purpose, coupling protrusions 422 can be formed on the outer perimeter of the side wall 420.

The outer coupling rim 430 and the inner coupling rim 440 can extend down from a lower portion of the cutter plate 400, where the outer coupling rim 430 can have a larger diameter than that of the inner coupling rim 440, so that a gap may be formed between the outer coupling rim 430 and the inner coupling rim 440. The outer coupling rim 430 and the inner coupling rim 440 can be used to couple the cutter plate 400 to the container body 200 and support the cutter plate 400 in a stable manner. For example, the inner coupling rim 440 of the cutter plate 400 can be inserted into the gap between the outer coupling rim 220 and inner coupling rim 212 of the container body 200, while the outer coupling rim 220 of the container body 200 can be inserted into the gap between the outer coupling rim 430 and the inner coupling rim 440.

One or more coupling indentations, coupling protrusions, securing indentations and/or securing protrusions can be formed on at least one of the outer coupling rim 430 and the inner coupling rim 440. For example, a coupling groove can be formed in the inner perimeter of the outer coupling rim 430. When the cutter plate 400 is coupled to the container body 200, the coupling protrusion 224 of the container body 200 can be inserted into the coupling groove formed in the outer coupling rim 430 of the cutter plate 400 so as to prevent the cutter plate 400 from becoming separated from the container body 200 along the longitudinal direction.

In the example shown in the drawings, securing grooves 434 are also formed in the inner coupling rim 440. The securing grooves 434 can be formed in one or more designated positions of the inner coupling rim 440 in the form of a groove that opens downward. When the cutter plate 400 is coupled to the container body 200, the securing protrusions 214 of the container body 200 can be inserted into the securing grooves 434 of the cutter plate 400 to thereby prevent the cutter plate 400 from rotating relative to the container body 200. While the above refers to the coupling protrusion 224 and the securing protrusions 214 being formed on the container body 200 and the coupling groove and securing grooves 434 being formed in the cutter plate 400, the positions of the protrusions and grooves can obviously be changed.

The cutter plate 400 can thus be coupled to an upper portion of the container body 200 in a manner that does not allow rotation relative to the container body 200. When using the grinding container 1100, a user may typically grip the dial 100 with one hand, grip the container body 200 with the other hand, and rotate these in opposite directions. Since the cutter plate 400 is coupled to the container body 200 as part of a structure that does not allow relative rotation, the cutter plate 400 can rotate together with the container body 200.

The overcap 500 can be detachably coupled to at least one of the container body 200 and the cutter plate 400 and can serve to cover the cutter plate 400. Referring to FIGS. 1 to 3, the overcap 500 can include a circular plate 510 and a side wall 520.

The circular plate 510, as the main part of the overcap 500, can form the upper surface of the overcap 500. The circular plate 510 can be formed in a size and shape that can fully cover the cover plate 410.

The side wall 520 can extend down from the edge of the circular plate 510. A coupling groove 522 can be formed in the inner perimeter of the side wall 520, and when the overcap 500 is coupled to the cutter plate 400, the coupling protrusions 422 of the cutter plate 400 can be inserted into the coupling groove 522 to allow a detachable coupling of the overcap 500.

The following provides a more detailed description, with reference to FIGS. 1 to 11, on the manner in which the grinding container 1100 according to an embodiment of the invention presented above may be assembled.

After each component of the grinding container 1100 has been fabricated, the piston 300 can be inserted into the mounting space 215 through the open top of the container body 200. The holder plate 310 of the piston 300 can remain in the mounting space 215 above the socket cylinder 250, whereas the stem 350 of the piston 300 can be inserted into the manipulation passageway 255 through the open top of the socket cylinder 250. While the mating protrusion 252 of the socket cylinder 250 and the thread 352 of the stem 350 are in a mated state, the piston 300 can be rotated such that the mating protrusion 252 moves along the thread 352, whereby the piston 300 can be moved down.

The dial 100 can be coupled to a lower portion of the container body 200, where the dial 100 can be coupled after or before the piston 300 has been moved down completely. When the dial 100 is coupled, the dial 100 can be pushed up while the guide pillars 180 of the dial 100 are inserted in the grooves 355 of the stem 350 and inserted through the guide slits 380 of the holder plate 310. As the dial 100 is pushed up, a lower portion of the coupling protrusion 244 on the lower coupling part 240 may contact the upper portions of the coupling protrusions 122 formed on the inner perimeter of the side wall 120 of the dial 100.

When the dial 100 is pushed up further, the side wall 120 may retreat outward and allow the coupling protrusion 244 of the lower coupling part 240 to pass over the coupling protrusions 122 on the side wall 120 of the dial 100, and the coupling protrusions 122, 244 may engage each other. The upper portions of the coupling protrusions 122 may be formed with slopes or curves, and the lower portion of the coupling protrusion 244 may also be formed with a slope or curve, allowing the coupling protrusions 244 of the lower coupling part 240 to pass over the coupling protrusions 122 of the dial 100 without much difficulty. Moreover, the allowance slits 115 formed on the inner side of the side wall 120 can allow portions of the side wall 120 to retreat outward without much difficulty.

When the dial 100 is properly coupled, the side wall 120 of the dial 100 may contact a lower portion of the main shell 210 and the outer perimeter of the lower coupling part 240, and the stationary sawtooth part 160 and the movable sawtooth part 260 formed on the dial 100 and the container body 200 may face each other. While the dial 100 is in a properly coupled state, the coupling protrusions 122 of the side wall 120 may be inserted in the coupling groove 242 of the lower coupling part 240 such that the dial 100 is unable to become separated along the longitudinal direction but is able to rotate in relation to the container body 200.

With the piston 300 arranged at its lowest possible position within the mounting space 215 in the grinding container 1100, as illustrated in FIG. 3, the lower end of the stem 350 of the piston 300 can touch the circular plate 110 of the dial 100, and the upper end of the socket cylinder 250 of the container body 200 can be positioned in the alignment groove 315 formed in the bottom surface of the holder plate 310.

The guide pillars 180 of the dial 100 can pass through the guide slits 380 of the holder plate 310 and extend to a particular position within the mounting space 215. Although it is not shown in the drawings, a solid content (not shown) can be provided on the holder plate 310, and the guide pillars 180 can extend to the inside of the content (not shown). While the grinding container 1100 is being manufactured, the solid content (not shown) can be prepared separately before being inserted into the mounting space 215 or can be supplied onto the holder plate 310 in the form of a liquid, etc., to be solidified afterwards at the corresponding position.

After the content (not shown) is supplied in the mounting space 215, the cutter plate 400 can be coupled to an upper portion of the container body 200. When the cutter plate 400 is pushed down while the securing grooves 434 of the cutter plate 400 are in an aligned state with respect to the securing protrusions 214 of the container body 200, the inner coupling rim 440 of the cutter plate 400 can be inserted into the gap between the inner coupling rim 212 and outer coupling rim 220 of the container body 200, and the outer coupling rim 220 of the container body 200 can be inserted into the gap between the outer coupling rim 430 and inner coupling rim 440 of the cutter plate 400. As the coupling protrusion 224 formed on the container body 200 is inserted into the coupling groove formed in the cutter plate 400, the cutter plate 400 can be secured to the container body 200, and the securing protrusions 214 inserted into the securing grooves 434 can secure the cutter plate 400 such that the cutter plate 400 is not able to rotate relative to the container body 200.

An overcap 500 can be detachably coupled as necessary to an upper portion of the above assembly consisting of the dial 100, container body 200, piston 300, and cutter plate 400.

The following provides a more detailed description, with reference to FIGS. 1 to 11, on the manner in which the grinding container 1100 according to an embodiment of the invention presented above may be used.

If a user wishes to use the grinding container 1100, the user can first separate the overcap 500 to expose the cutter plate 400. The user can grip the container body 200 with one hand and grip the dial 100 with the other hand. When the user rotates the dial 100, the rotational force of the dial 100 may be transferred to the piston 300, since the guide pillars 180 of the dial 100 are inserted in the grooves 355 of the piston 300, so that the piston 300 may rotate together with the dial 100 in relation to the container body 200.

When the user rotates the dial 100, an interaction may occur between the stationary sawtooth part 160 and the movable sawtooth part 260 that are provided on the dial 100 and the container body 200.

As depicted in the lower right drawing of FIG. 3, the stationary sawtooth 170 of the stationary sawtooth part 160 may have a sloped surface 176 on one side and a stopper surface 178 on the other side, whereas the movable sawtooth 270 of the movable sawtooth part 260 may have a stopper surface 278 on one side and a sloped surface 276 on the other side. If the dial 100 is rotated in a first direction, the sloped surface 276 (second sloped surface) of the movable sawtooth 270 may contact the sloped surface 176 (first sloped surface) of the stationary sawtooth 170. Since the cantilever portion 272 allows the sawtooth portion 274 of the movable sawtooth 270 to retract in a direction away from the stationary sawtooth 170, the contact between the sloped surface 276 of the movable sawtooth 270 and the sloped surface 176 of the stationary sawtooth 170 may cause the sawtooth portion 274 of the movable sawtooth 270 to move along the sloped surface 176 and retract away from the stationary sawtooth 170.

As the dial 100 is rotated such that the movable sawtooth 270 passes over one stationary sawtooth 170, the movable sawtooth 270 can be returned to its original position by the elasticity of the cantilever portion 272, at which time the movable sawtooth 270 can collide with the stationary sawtooth part 160 and cause an impact noise and vibration. As the dial 100 is rotated further, the movable sawtooth 270 can interact with the next stationary sawtooth 170. Of course, when one stationary sawtooth 170 is made to interact with many movable sawteeth 270 arranged continuously, the structure can involve the stationary sawtooth 170 interacting with the next movable sawtooth 270. From the impact noise and vibration created by the movable sawtooth part 260, the user can auditorily and tactually perceive the degree to which the dial 100 is rotated.

If the dial 100 is rotated, not in the first direction intended for operating the grinding container 1100, but in the opposite direction, i.e., a second direction, then the stopper surface 278 (second stopper surface) of the movable sawtooth 270 may contact the stopper surface 178 (first stopper surface) of the stationary sawtooth 170. Here, since the sawtooth portion 274 of the movable sawtooth 270 is being pushed in thee direction in which the cantilever portion 272 extends and therefore is not being pushed in a retractable direction, the movable sawtooth 270 may be caught on the stationary sawtooth 170 and may thus prevent the dial 100 from rotating in the second direction. The above structure of the grinding container 1100 can help the user to rotate the dial 100 only in the first direction for proper operation and thus can prevent situations where the user is confused by not being able to obtain the content in spite of rotating the dial 100.

When the dial 100 is rotated in the correct direction, the piston 300 may rotate with respect to the container body 200. Since there is a screw mating of the thread 352 and the mating protrusion 252 between the piston 300 and the container body 200, the mating protrusion 252 may move along the thread 352, and the holder plate 310 of the piston 300 may gradually move upward within the mounting space 215.

As the holder plate 310 moves up, the content (not shown) supplied on the upper surface of the holder plate 310 may move up together and may come into contact with the bottom surface of the cover plate 410. The cutter plate 400 is secured to the container body 200 in a non-rotatable manner, the piston 300 is secured to the dial 100 in a non-rotatable manner, and the container body 200 and the dial 100 are rotatable in relation to each other. Therefore, from the perspective of the piston 300, the cover plate 410 is rotated relative to the holder plate 310 by the same force applied by the user on the dial 100. The cutter blades 412, 414 of the cover plate 410, which is thus being rotated relative to the holder plate 310, can scrape and grind the upper surface of the solid content (not shown), and the ground content can run along the cutter blades 412, 414 and through the discharge holes 415, 417 to be provided on the upper surface of the cover plate 410. The user can apply the content, which has thus been provided on the upper surface of the cover plate 410 in a powder form, onto a target area by using a cosmetic tool such as a puff, etc.

When the user rotates the dial 100, the contact part 330 of the piston 300 can contact the main shell 210 of the container body 200 in a resilient manner. If an excessive amount of force were to occur, the connecting part 320 and connecting flange 322 between the holder plate 310 and the contact part 330 can absorb some of the excess force.

The diameters of the stem 350 of the piston 300 and the socket cylinder 250 of the container body 200 can be greater than or equal to a half of the diameter of the holder plate 310 of the piston 300, so that the piston 300 is able to maintain an aligned state in a stable manner, even if a solid content (not shown) of a considerable weight is placed on the holder plate 310.

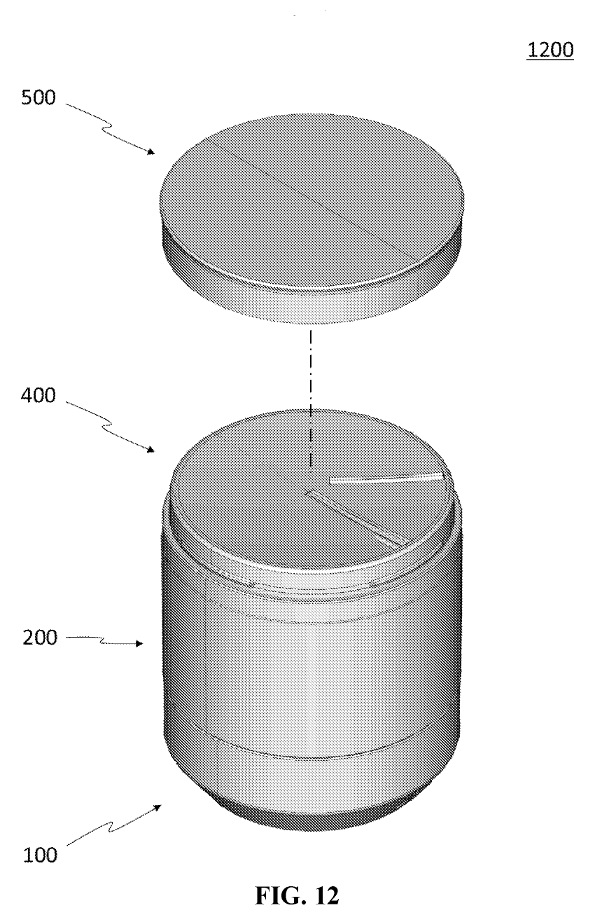

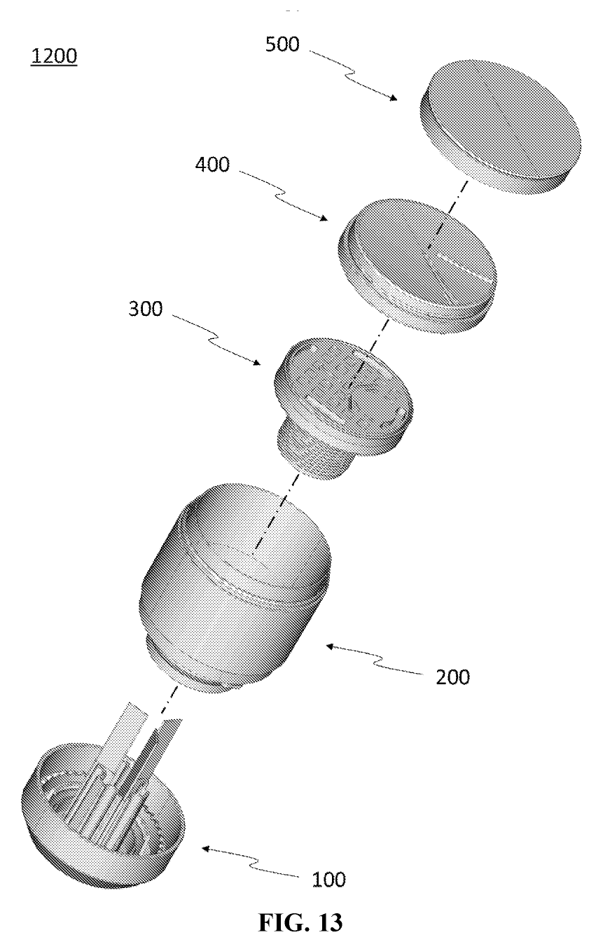

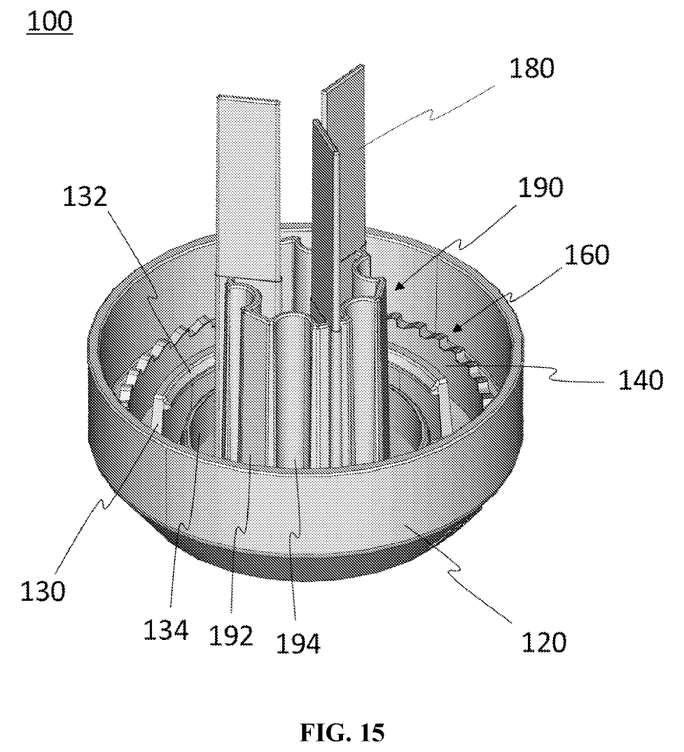

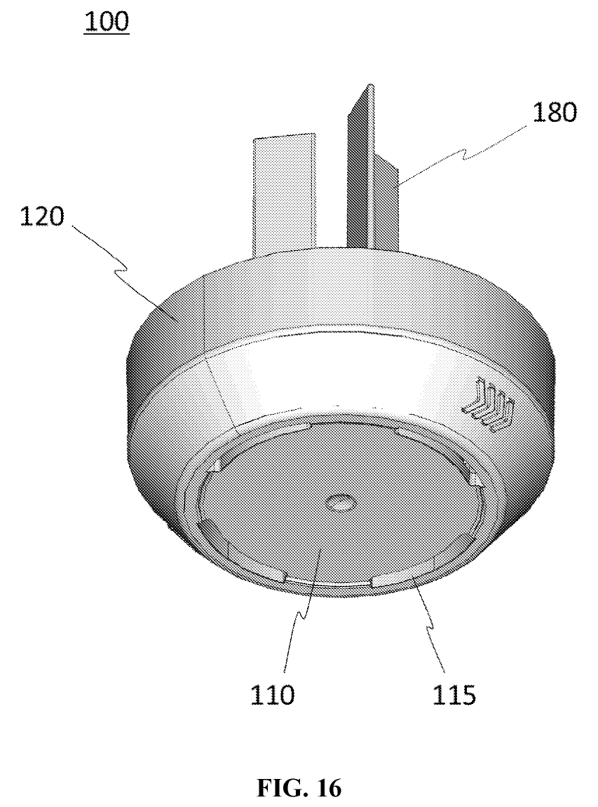

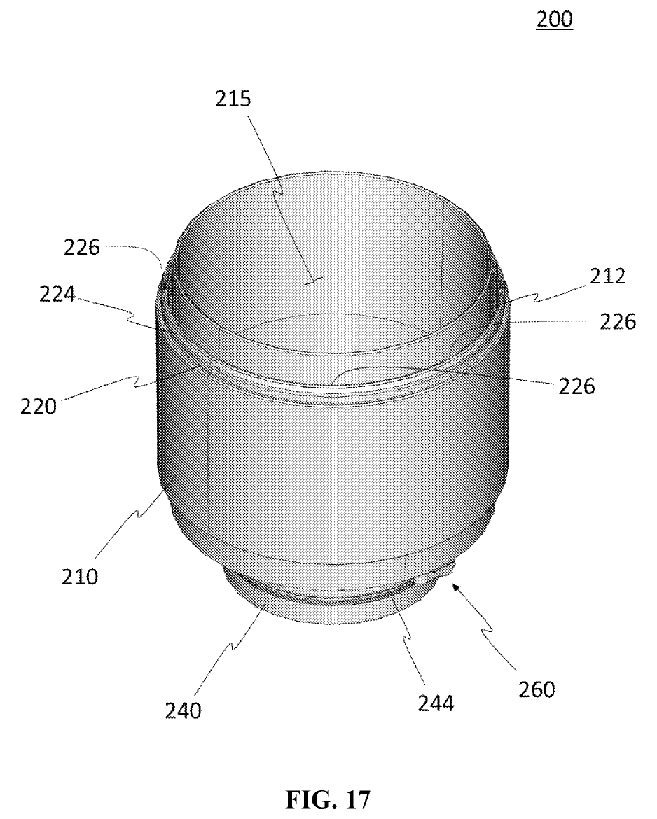

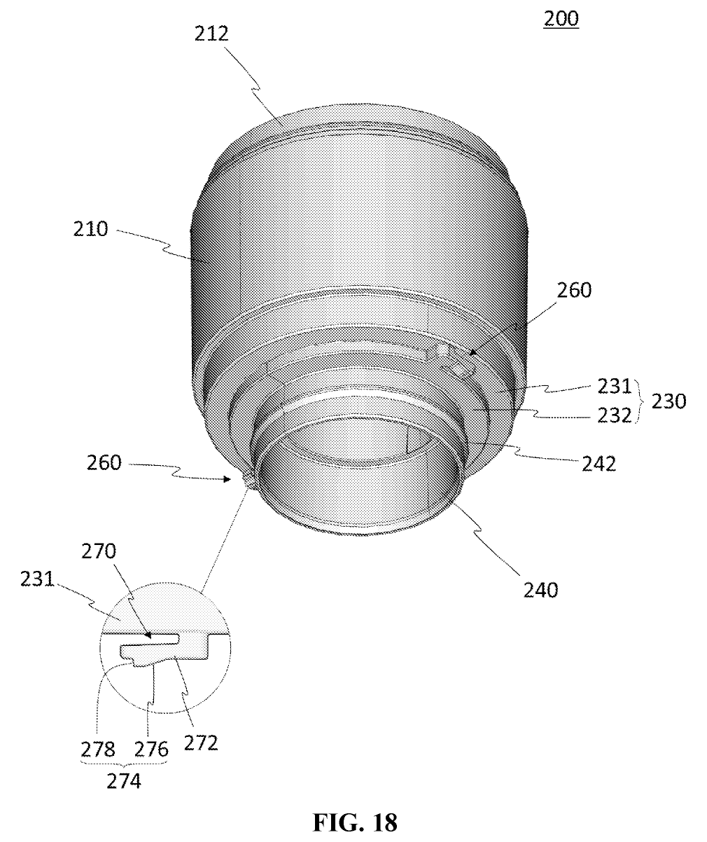

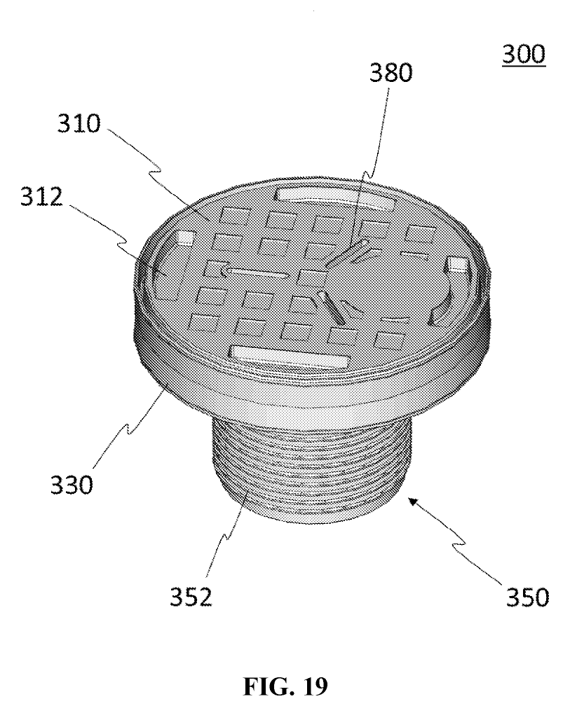

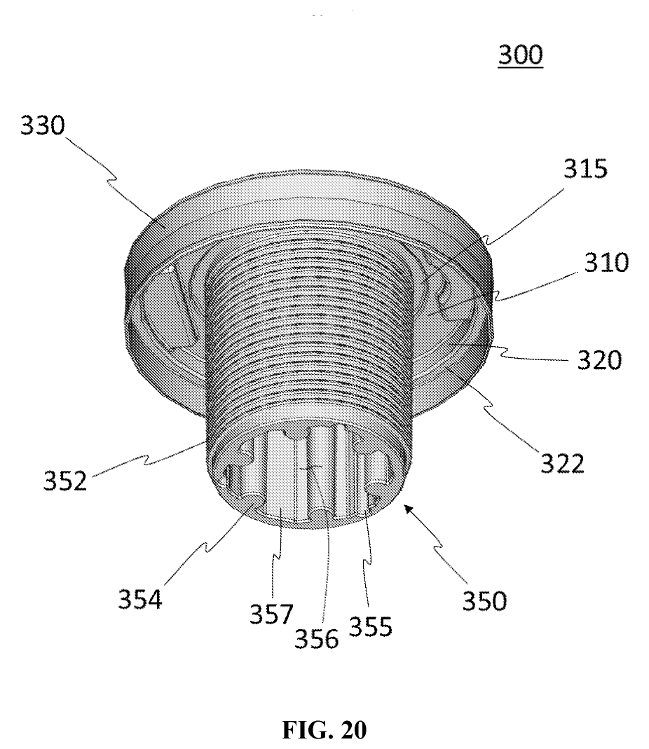

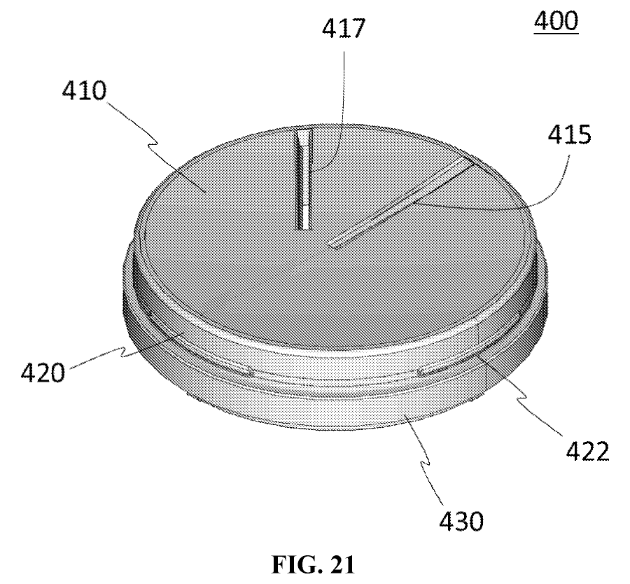

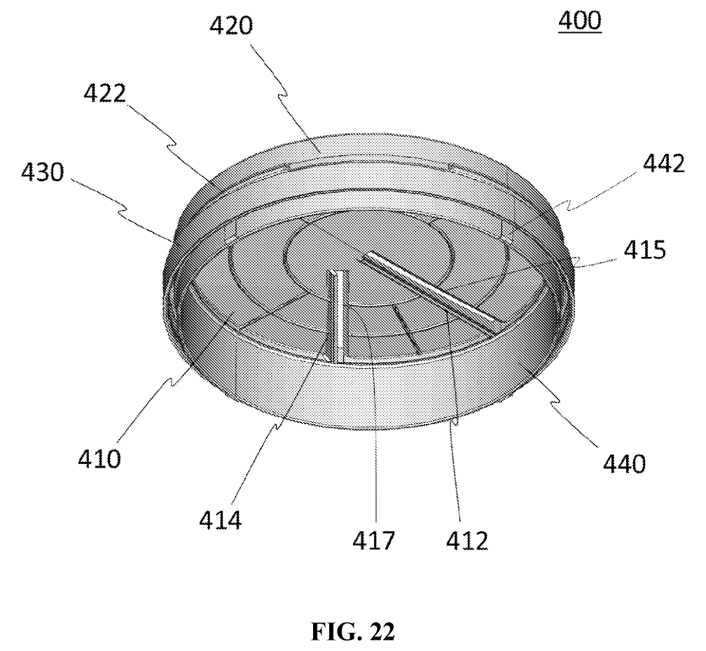

FIG. 12 through FIG. 14 illustrate a grinding container 1200 according to a second disclosed embodiment of the invention. A grinding container 1200 based on the second disclosed embodiment of the invention as described below can be used, for example, when the grinding container is to be manufactured in a size greater than that of a grinding container 1100 based on the first disclosed embodiment of the invention. As illustrated in FIG. 12 through FIG. 14, a grinding container 1200 according to an embodiment of the invention can include a dial 100, a container body 200, a piston 300, a cutter plate 400, and an overcap 500. FIG. 15 and FIG. 16 illustrate the dial 100 in greater detail, while FIG. 17 and FIG. 18 illustrate the container body 200 in greater detail. FIG. 19 and FIG. 20 illustrate the piston 300 in greater detail, while FIG. 21 and FIG. 22 illustrate the cutter plate 400 in greater detail.

A grinding container 1200 based on the second disclosed embodiment of the invention can have many features in common with a grinding container 1100 based on the first disclosed embodiment described above, and the descriptions below will focus more on the differences of the grinding container 1200 based on the second disclosed embodiment. Features described with respect to the first disclosed embodiment can be applied to the second disclosed embodiment, and features described with respect to the second disclosed embodiment can likewise be applied to the first disclosed embodiment. Certain reference numerals mentioned in the description of the second disclosed embodiment are intended to refer to corresponding components of the components to which the numerals are assigned in the first disclosed embodiment.

Referring to FIG. 15 and FIG. 16, a dial 100 according to an embodiment of the invention can further include coupling rims 130 and an insertion coupling part in addition to the circular plate 110, side wall 120, protruding inner wall 140, stationary sawtooth part 160, and guide pillars 180 described above.

The coupling rims 130 can be provided for coupling the dial 100 to the container body 200 and can provide locations for the coupling protrusions 132. While it is possible to have the coupling protrusions 122 formed on the side wall 120 for a rotatable coupling of the dial 100, as in the first disclosed embodiment described above, a grinding container 1200 of a relatively larger size can include a separate set of coupling rims 130 and can have the coupling protrusions 132 formed on the coupling rims 130, so that the dial 100 may be coupled more stably.

The coupling rims 130 can extend upward from the circular plate 110, from positions corresponding to the lower coupling rim 240 of the container body 200. The coupling protrusions 132 can be formed on the upper portions of the coupling rims 130. The dial 100 can include a multiple number of coupling rims 130, where each of the coupling rims 130 can have cross sections shaped as arcs centering around the center of the circular plate 110. As illustrated in FIG. 14, the coupling rims 130 can be inclined so as to incline inward towards the top. In cases where the coupling protrusions 132 are formed on coupling rims 130, the allowance slits 115 formed in the circular plate 110 can be formed adjacent to the coupling rims 130, respectively.

A grinding container 1200 according to an embodiment of the invention can further include a support protrusion 134. The support protrusion 134 can be formed at a position corresponding to the lower coupling rim 240 of the container body 200 but on the opposite side of the coupling rims 130 with respect to the lower coupling rim 240. In the example shown in FIGS. 14 to 16, the coupling rims 130 are located on the outer side of the lower coupling rim 240, while the support protrusion 134 is formed on the inner side of the lower coupling rim 240. Thus, when the dial 100 is coupled to the container body 200, the lower coupling rim 240 can be supported on the outer side by the coupling rims 130 and supported on the inner side by the support protrusion 134. In an embodiment not shown in the drawings, the coupling rims 130 can be located on the inner side of the lower coupling rim 240, and the support protrusion 134 can be located on the outer side of the lower coupling rim 240. In this case, the coupling protrusions 132 can be formed on the outer perimeters of the coupling rims 130.

The insertion coupling part can extend upward from the circular plate 110. The insertion coupling part may be configured to engage the stem 350 of the piston 300. Either one of the insertion coupling part and the stem 350 can include an insertion space formed on the inner side, and the other of the insertion coupling part and the stem 350 can include a support pillar that is inserted into this insertion space. In the example shown in the drawings, the stem 350 of the piston 300 is implemented with an insertion space 356, and the insertion coupling part of the dial 100 is implemented in a form that includes a support pillar 190.

The support pillar 190 can extend up from the circular plate 110 and, so as to be inserted into the insertion space 356 formed in the stem 350, can have a cross section shaped in correspondence to the shape of the insertion space 356. Although FIG. 15 depicts the support pillar 190 as having a hollow form, it is not necessary for the support pillar 190 to have a hollow interior unless another component is configured to be inserted to the inner side of the support pillar 190. If some component of the stem 350 were to have a shape corresponding to the interior space of the support pillar 190 and were to be inserted into the interior space, then said component would in effect serve as the support pillar, and the interior space would in effect correspond to the insertion space included in the insertion coupling part.

The support pillar 190 can be formed in a non-circular shape so as not to be capable of rotating after being inserted in the insertion space 356. According to an embodiment of the invention, inwardly recessed portions 194 can be formed in the outer surfaces of the support pillar 190, as a result of which the unrecessed portions of the support pillar 190 can form protruding portions 192 that protrude outward in comparison.

In cases where the dial 100 includes a support pillar 190 having a hollow interior as illustrated in FIG. 15, the guide pillars 180 can be implemented in a shape such that portions of the guide pillars 180 intersect portions of the support pillar 190. That is, some portions of the guide pillars 180 can be located on the outer side of the support pillar 190, while some portions of the guide pillars 180 can be located on the inner side of the support pillar 190. Such a structure allow a very firm and stable coupling between the insertion coupling part (i.e., the support pillar 190) and the stem 350.

In this embodiment also, the container body 200 may correspond to the main part of the grinding container 1200, and its main function may be substantially the same as the container body 200 of the first disclosed embodiment described above.

As already described above, one or more coupling indentations, coupling protrusions, securing indentations and/or securing protrusions can be formed on at least one of the inner coupling rim 212 and the outer coupling rim 220. In the example shown in FIG. 17, securing indentations 226 are formed in the inner perimeter of the outer coupling rim 220. The securing indentations 226 can be inwardly recessed at one or more designated positions in the inner perimeter of the outer coupling rim 220. When the cutter plate 400 is coupled to the container body 200, the securing protrusions 442 of the cutter plate 400 can be inserted into the securing indentations 226 formed in the outer coupling rim 220 to thereby prevent the cutter plate 400 from rotating in relation to the container body 200.

Referring to FIG. 18, the floor part 230 can be divided into two levels to include a first floor part 231 and a second floor part 232. As the floor part 230 forms several steps from the main shell 210, the dial 100 can be more firmly coupled to the container body 200. In the example shown in FIG. 18, the movable sawtooth part 260 includes two movable sawteeth 270, where one end of the cantilever portion 272 of each movable sawtooth 270 is connected to both the first and the second floor parts 231, 232 so as to be firmly secured, while the sawtooth portion 274 is placed in the space formed by the level difference between the first floor part 231 and the second floor part 232.

Referring to FIG. 19 and FIG. 20, the piston 300 of this embodiment can be generally similar in shape and structure to the piston 300 of the first disclosed embodiment described above and can mainly include a holder plate 310, a connecting part 320, a contact part 330, and a stem 350.

The holder plate 310 of this embodiment may be similar overall to the holder plate 310 of the first disclosed embodiment described above. Referring to FIG. 19, recessed portions 312 can be formed in the upper surface of the holder plate 310 in addition to the rectangular indentations, where the recessed portions 312 may be recessed more deeply.

As described above, one of the insertion coupling part of the dial 100 and the stem 350 of the piston 300 can include an insertion space formed on the inner side, while the other of the insertion coupling part and the stem 350 can include a support pillar that is inserted into this insertion space. In the grinding container 1200 based on the second disclosed embodiment of the invention shown in the drawings, the insertion coupling part of the dial 100 includes the support pillar 190, while the stem 350 of the piston 300 includes the insertion space 356.

Referring to FIG. 15 and FIG. 20, the insertion space 356 of the stem 350 can be formed in a shape corresponding to the cross section of the outer surface of the support pillar 190. Thus, if the support pillar 190 includes inwardly recessed portions 194 and outwardly protruding portions 192, then the inner surfaces of the stem 350 forming the insertion space 356 can correspondingly include outwardly recessed portions 357 and inwardly protruding portions 354. As illustrated in FIG. 20, even with this structure, there can still be grooves 355 formed on the inner side of the stem 350, and the outer portions of the guide pillars 180 can be inserted into the grooves 355.

Referring to FIG. 21 and FIG. 22, the cutter plate 400 of this embodiment can be generally similar in shape and structure to the cutter plate 400 of the first disclosed embodiment described above and can mainly include a cover plate 410, a side wall 420, an outer coupling rim 430, and an inner coupling rim 440.

As described above, one or more coupling indentations, coupling protrusions, securing indentations and/or securing protrusions can be formed in at least one of the outer coupling rim 430 and inner coupling rim 440. In the example shown in FIG. 22, securing protrusions 442 are formed on the outer perimeter of the inner coupling rim 440. When the cutter plate 400 is coupled to the container body 200, the securing protrusions 442 of the cutter plate 400 can be inserted into the securing indentations 226 formed in the container body 200 to thereby prevent the cutter plate 400 from rotating in relation to the container body 200.

Certain embodiments of the invention as set forth above provide a grinding container 1100, 1200 that is convenient to use, as the user can grind the solid content with a simple action of rotating the dial 100. The grinding container 1100, 1200 allows the user to perceive the extent to which the dial 100 is rotated, so that the user may manipulate the grinding container 1100, 1200 with meticulosity and grind the content in a desired, suitable amount every time. Also, the grinding container 1100, 1200 can prevent the dial 100 from rotating in the opposite direction, thus saving the user from unnecessary confusion.

In a grinding container 1100, 1200 according to an embodiment of the invention, the parts that move and the parts that support such moving parts are flexible to a suitable extent, so that the content may be aligned and support in a stable manner. This allows the grinding container 1100, 1200 to have high durability.

While the foregoing provides a description with reference to an embodiment of the invention, it should be appreciated that a person having ordinary skill in the relevant field of art would be able to make various modifications and alterations to the invention without departing from the spirit and scope of the invention set forth in the scope of claims below.

What is claimed is:

1. A grinding container comprising:
a container body having a main shell and a socket cylinder, the main shell forming a mounting space on an inner side thereof, the mounting space being open at a top, the socket cylinder located at a lower portion on an inner side of the main shell and extending a particular length along a longitudinal direction, the socket cylinder forming a manipulation passageway on an inner side thereof such that the mounting space is in communication with an exterior;
a cutter plate secured in relation to the container body at a position covering the top of the mounting space, the cutter plate having a cutter blade on a bottom surface thereof and having a discharge hole formed therein, the cutter blade configured to grind a solid content, the discharge hole penetrating the cutter plate along the longitudinal direction to discharge the ground solid content;
a piston having at least a portion thereof arranged within the mounting space to support the solid content, the piston having a guide slit formed in an upper surface thereof, the guide slit penetrating the upper surface of the piston along the longitudinal direction, the piston configured to be movable along the longitudinal direction in relation to the container body; and
a dial rotatably coupled to a lower portion of the container body and having a guide pillar, the guide pillar extending upward into the mounting space, the guide pillar inserted through the manipulation passageway into the guide slit such that an upper end of the guide pillar is located within the mounting space,
wherein the piston comprises a stem extending downward such that at least a portion of the stem is located within the manipulation passageway, a thread is provided on one of an inner perimeter of the socket cylinder and an outer perimeter of the stem, and a mating protrusion configured to engage the thread is provided on an other of the inner perimeter of the socket cylinder and the outer perimeter of the stem.

2. The grinding container of claim 1, wherein one of the container body and the dial comprises a stationary sawtooth part and an other of the container body and the dial comprises a movable sawtooth part,
the stationary sawtooth part comprises at least one stationary sawtooth protruding along the longitudinal direction or a radial direction, the movable sawtooth part comprises at least one movable sawtooth, and
the movable sawtooth comprises a cantilever portion and a sawtooth portion, the cantilever portion having one end thereof secured, the sawtooth portion protruding in an opposite direction of a protruding direction of the stationary sawtooth.

3. The grinding container of claim 2, wherein the stationary sawtooth part includes a plurality of stationary sawteeth formed continuously along an annular path.

4. The grinding container of claim 2, wherein the movable sawtooth part includes a plurality of movable sawteeth formed continuously along an annular path.

5. The grinding container of claim 2, wherein the stationary sawtooth includes a first sloped surface formed on one side and a first stopper surface formed on an other side with respect to a circumferential direction, the movable sawtooth includes a second sloped surface formed on the other side and a second stopper surface formed on the one side with respect to the circumferential direction, such that rotating the dial in a first direction causes the first sloped surface to contact the second sloped surface and rotating the dial in a second direction causes the first stopper surface to contact the second stopper surface, the second direction being an opposite direction of the first direction.

6. The grinding container of claim 2, wherein the container body comprises a floor part having a flat shape provided at a lower portion of the main shell, and the stationary sawtooth part or the movable sawtooth part is formed on the floor part.

7. The grinding container of claim 1, wherein a groove extending along the longitudinal direction is formed in an inner perimeter of the stem, and
an outer side of the guide pillar is inserted in the groove.

8. The grinding container of claim 1, wherein the dial comprises an insertion coupling part extending upward,
one of the insertion coupling part and the stem forms an insertion space on an inner side thereof, an other of the insertion coupling part and the stem comprises a support pillar inserted into the insertion space, and a cross section of the insertion space and a cross section of the support pillar are formed in non-circular shapes so as to prevent the piston from rotating in relation to the dial while allowing the piston to move along the longitudinal direction in relation to the dial.
